(19) United States
(12) Patent Application Publication
(10) Pub. No.: US 2003/0219155 A1
(43) Pub. Date: Nov. 27, 2003

(54) Resin appearance designing method and apparatus

(76) Inventors: Hidemasa Azuma, Nagoya-shi (JP); Hitoshi Takayama, Nagoya-shi (JP); Yoshihito Nakahara, Nagoya-shi (JP); Kentaro Hayashi, Nagoya-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 09/738,355

(22) Filed: Dec. 18, 2000

Related U.S. Application Data
(63) Continuation of application No. PCT/JP99/03273, filed on Jun. 18, 1999.

(30) Foreign Application Priority Data
Jun. 18, 1998 (JP) 10-171514
Jun. 18, 1998 (JP) 10-171515
Nov. 11, 1998 (JP) 10-320809

(51) Int. Cl. G06K 9/62; G06K 9/00

(52) U.S. Cl. 382/156; 382/162

(57) ABSTRACT

In the prediction of a resin pattern, images of a plurality of sample resins corresponding to pattern material information are captured first. Then, from among the captured images, a plurality of images are selected on the basis of the pattern material data, and are combined to synthesize an image for output. The image synthesis and output process is repeated by varying the pattern material data until the output image shows a desired resin pattern, and thereby the pattern material data for obtaining a resin having the desired resin pattern is determined. In the prediction of a resin color, the color of a resin molding is predicted from color material data, and the predicted image is output. The prediction and output process is repeated by varying the color material data until the output image matches an image of a resin molding having a desired color, and thereby the color material data for obtaining the resin molding having the desired color is determined.

### CROSS-REFERENCE TO RELATED APPLICATIONS

This application is based upon and claims priority of Japanese Patent Application No. 10-171514, filed Jun. 18, 1998, No. 10-171515 filed Jun. 18, 1998 and No. 10-320809 filed Nov. 11, 1998, the contents being incorporated therein by reference, and a continuation of PCT/JP99/03273.

### TECHNICAL FIELD

The present invention relates to a method of designing a resin pattern by predicting the result from the kind of pattern material used to form a pattern, the kind of base resin material, and the mixing ratios of these materials, and also relates to an apparatus equipped with a function for designing a resin color using computer color matching techniques.

### PRIOR ART

In recent years, computer color matching (hereinafter abbreviated CCM) has come to be used as a handy means for predicting the result of colorant mixing ratios for coloring materials such as inks and paints. This means has also been applied in resin manufacturing to predict the color of a manufactured resin, to determine the mixing ratios of pigments from the color of a sample resin, and so on.

Such applications, however, have been limited to resins whose color tone or shade is substantially uniform over the entire surface (solid color resins), and an appearance design involving pattern information has not been reported. Naturally, the development of an apparatus that is equipped with both the CCM and resin pattern design functions has not been reported.

On the other hand, as a method of obtaining the texture of a material surface by calculation, there has been known a method of calculating the degree of variation in color at many points on the surface as an index of decorativeness expressing high quality appearance (Japanese Unexamined Patent Publication No. 7-049224).

However, with such an index of color unevenness, the calculated value cannot uniquely express the texture unless the application is limited to a specific target (in the above example, finished texture of a tile surface). That is, since there is the possibility that the same index value may represent entirely different textures, it has been difficult to apply the method to the designing of diverse textures such as resin patterns. On the other hand, as earlier noted, with conventional CCM, it has not been possible to handle textures.

Generally, in conventional CCM, the spectral reflectance of a given mixture is obtained in accordance with Duncan's equation and the equation based on the Kubelka-Munk color mixing theory by using the absorption and scattering coefficients of colorants and an object to be colored.

When the spectral reflectance of the mixture is known, then the tristimulus values of the mixture can be calculated, and thus the color of the mixture can be computed.

Various known techniques for correcting the above coefficients can be used to implement methods for reducing prediction errors and enhancing the prediction accuracy. As an example, there is proposed a method that corrects for these prediction errors by using a neural network (Japanese Unexamined Patent Publication No. 8-94442).

On the other hand, the Kubelka-Munk color mixing theory assumes as a set model a homogenous coloring material layer formed with a colorant and the substrate of an object to be colored. In the case of a resin plate or the like in which a colorant is mixed into the object to be colored, the above values are calculated by treating the entire mixture as the coloring material layer. Accordingly, for the resin plate as the coloring material layer, unless the colorant and the object to be colored are mixed uniformly at the molecular level, the assumption that the theory uses does not hold, and it cannot accurately provide the absorption and scattering coefficients of the colorant and the object to be colored.

In addition, since the prediction based on the above CCM entails a substantial amount of error, it usually takes a considerable amount of trouble and repeated trial and error to obtain a sample of the desired color from the predicted mixing ratio. To alleviate this problem, Japanese Unexamined Patent Publication No. 8-178752 proposes a method in which a database defining the relationships between the mixing ratios of pigments and the measured color values of the samples prepared based thereon is created in advance and a search is conducted for a mixing ratio for a sample whose color is closest to the desired color.

In this method, however, to accurately predict the mixing ratio, a considerable amount of data has to be stored in the database, and for that purpose, an enormous number of samples have to be created for various colors.

Accordingly, with conventional computer color matching, the mixing ratio with which to produce a mixture having the desired color has been difficult to accurately predict.

Furthermore, in the case of patterned resins which generally have high design quality compared with solid color resins, a considerable number of samples have to be created in order to produce a resin having the desired texture, as described above, and the design work has had to rely on experience of skilled persons.

### DISCLOSURE OF THE INVENTION

The present invention has been devised to solve the above problems, and it is an object of the invention to provide an apparatus having either a resin color designing function with an ability to predict the kind of colorant and the mixing ratio of the colorant (hereinafter referred to as the color material information) necessary for manufacturing a resin having the desired color, or a resin molding pattern designing function with an ability to predict the kind of pattern material used to form the pattern, the kind of base resin material, and the mixing ratios of these materials from a synthesized image having the desired resin texture (pattern texture), the synthesized image being produced by combining pattern images of a plurality of resins manufactured by varying the mixing ratio.

It is also an object of the present invention to expand the application range of resin appearance design by providing both the pattern prediction function and color prediction function described above. Such functions include, for example, predicting the pattern of a resin having a novel texture (pattern texture) by assuming an unknown color for the pattern material.

According to the present invention, there is provided a resin appearance designing method comprising the steps of: (a) capturing images of a plurality of sample resin moldings whose pattern material information is known; (b) synthesizing an image from a plurality of images selected from among the captured images on the basis of pattern material data; (c) outputting the synthesized image: and (d) repeating the steps (b) and (c) by varying the pattern material data until the output image shows a desired resin pattern, and thereby determining the pattern material data for obtaining a resin molding having the desired resin pattern.

According to the present invention, there is also provided a resin appearance designing method comprising the steps of: (a) predicting the color of a resin molding from color material data; (b) outputting the predicted color of the resin molding in the form of an image; and (c) repeating the steps (a) and (b) by varying the color material data until the output image matches an image of a resin molding having a desired color, and thereby determining the color material data for obtaining the resin molding having the desired color.

According to the present invention, there is also provided a resin appearance designing apparatus comprising: means for capturing images of sample resin moldings; means for storing the images captured by the capturing means; means for synthesizing an image from a plurality of images selected from among the stored images; and means for outputting the synthesized image.

According to the present invention, there is also provided a resin appearance designing apparatus comprising: means for predicting the color of a resin molding from color material data; and means for outputting the predicted color of the resin molding in the form of an image.

### BRIEF DESCRIPTION OF THE DRAWINGS

FIG. 1 is a simplified block diagram showing a resin appearance designing apparatus according to the present invention;

FIG. 2 is a diagram showing a first example of a neural network for correcting a base resin color;

FIG. 3 is a diagram showing a second example of the neural network for correcting a base resin color;

FIG. 4 is a flowchart illustrating a process for generating an image of a resin containing multiple kinds of pattern materials by combining images of a plurality of resins each containing one kind of pattern material;

FIGS. 5, 6, and 7 are graphs each showing an example of a sigmoid function;

FIG. 8 is a diagram showing an example of a neural network for predicting color from a colorant mixing ratio;

FIG. 9 is a flowchart illustrating a process for predicting the color of a resin containing two kinds of colorants in arbitrary proportions; and

FIG. 10 is a diagram for explaining coordinate conversion.

### BEST MODE OF CARRYING OUT THE INVENTION

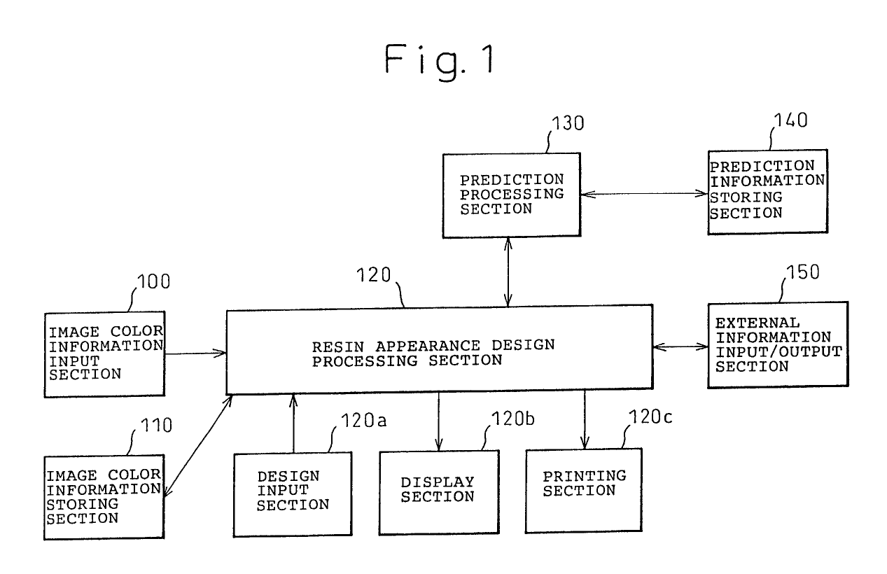

One embodiment of the present invention will be described below with reference to drawings. FIG. 1 is a simplified block diagram showing an example of a resin appearance designing apparatus according to the present invention.

In the figure, the resin appearance designing apparatus comprises an image color information input section 100, an image color information storing section 110, a resin appearance design processing section 120, a design input section 120a, a display section 120b, a printing section 120c, a prediction processing section 130, a prediction information storing section 140, and an external information input/output section 150.

The function of each section of the apparatus will be described below.

The image color information input section 100 is one for capturing an image and/or color information of a resin, and a device capable of capturing color/pattern information in numeric form, such as a calorimeter, a scanner, or a digital camera, is used for this purpose.

The information captured through the image color information input section 100 and/or the external information input/output section 150 is stored in the image color information storing section 110 by way of the resin appearance design processing section 120 described hereinafter. Further, a synthesized image from the prediction processing section 130 described hereinafter is stored as needed as a prediction result in the image color information storing section 110 by way of the resin appearance design processing section 120. The information stored in the image color information storing section 110 is used for such purposes as storing or reusing a standard, a sample image, and/or color information.

The resin appearance design processing section 120 includes a storing means (hereinafter referred to as the temporarily storage device) for temporarily storing information, such as the kind of colorant, colorant loadings, the kind of pattern material, the kind of base resin material, the mixing ratios of these materials, etc. necessary for the resin appearance design, and performs the following processing in accordance with a processing command and/or input data from the design input section 120a.

Here, it is desirable to construct the temporary storage device from a device such as a RAM capable of storing and reproducing information at high speed, but another type of device (such as a fixed disk or an MO disk) can also be used, provided that the device can process information in real time.

(1) The image or color information from the image color information input section 100 and/or the external information input/output section 150 and/or from the prediction processing section 130 hereinafter described is read into the temporary storage device and stored in the image color information storing section 110. Or, the image or color information stored in the image color information storing section 110 is read into the temporary storage device.

(2) The image representing the prediction result and/or the image or color information read into the temporary storage device in the above processing (1), etc. are output to the display section 120b and/or the printing section 120c.

For the display device, a CRT or any other kind of device, such as a liquid crystal display or a plasma display, can be used, provided that the device is capable of displaying the above information, and for the printing device, a printer such as a page printer or any other kind of device such as a plotter can be used, provided that the device is capable of printing the above information.

(3) Information such as material information described hereinafter is created and stored in the temporary storage device in accordance with a processing command and/or input data from the design input section 120a, or such information stored in the temporary storage device is altered or deleted. By outputting in the above processing (2) the prediction result from the prediction processing section 130 described hereinafter onto the display section 120b and/or the printing section 120c based on the pattern material information thus created, the information can be altered to match the desired image, that is, the appearance can be designed, while checking the result of the alteration on the screen and/or a printed sheet.

(4) The material information created in the above processing (3) is supplied to the prediction processing section 130.

(5) The following control is performed in the prediction processing section 130 described hereinafter. That is, a command signal is supplied to the prediction processing section 130, instructing the prediction processing section 130 to create prediction information, in accordance with a method hereinafter described, from the information supplied to the prediction processing section 130 in the above processing (3), or to make a prediction from the material information in accordance with a method hereinafter described.

The prediction processing section 130 performs one or the other of the following processes in accordance with the command signal supplied from the resin appearance design processing section 120.

(1) Using the information supplied from the resin appearance design processing section 120 and the input data (material information) received from the design input section 120a by way of the resin appearance design processing section 120, the following processing is performed; that is, when carrying out the pattern prediction function, then, information such as a processing program and parameters (hereinafter referred to as the pattern prediction information) necessary for making a prediction for an image, or when carrying out the color prediction function, then, information necessary for predicting a coloring material (hereinafter referred to as the color prediction information), is created as a database and stored in the prediction information storing section 140.

(2) The pattern prediction information or color prediction information created and stored in advance in the above processing (1) is read out of the prediction information storing section 140 and, based on this information, the pattern or color prediction is performed by extracting as needed the image or color information from the image color information storing section 110 via the resin appearance design processing section 120, and the result is supplied to the resin appearance design processing section 120.

The prediction information storing section 140 stores the prediction information created by the prediction processing section 130 in the above processing.

For the prediction information storing section, it is desirable to use a device, such as a hard disk or an MO disk, that does not require special energy (power, etc.) in order to continuously retain the stored information, but other type of device (RAM, etc.) can be used, provided that the device is capable of continuously retaining the stored information.

The various kinds of information such as image, color, and material information used in the apparatus or created in the apparatus are not only transferred between the devices within the apparatus, but with the provision of the external information input/output section 150, such information can also be transferred to and from another device or apparatus (hereinafter called an external device).

For the external information input/output section, a magnetic recording medium such as an MO disk or a floppy disk can be used, but another device (network connection device, etc.) can also be used if the device is capable of transferring information to and from an external device.

The design input section 120a is provided to input, alter, or delete various kinds of data, such as the resin material information (describing the kinds, colors, and particle distributions of the coloring material and pattern material, and their mixing ratios relative to the base resin) and the image or color information, and also to enter a processing command for controlling each section of the apparatus. The processing command and/or input data from the design input section 120a is read into the temporary storage device in the resin appearance design processing section 120 to perform the above-described processing.

As the device for the design input section, a keyboard, a pointing device such as a mouse, a tablet, or other kind of device that can be used to input, alter, or delete the above information is used.

The display section 120b displays the image or color information or resin material information stored in the temporary storage device in the resin appearance design processing section 120, the prediction result supplied from the prediction processing section 130, etc., in accordance with a processing command entered from the design input section 120a described above.

For the display device, a CRT or any other kind of device, such as a liquid crystal display or a plasma display, can be used, provided that the device is capable of displaying the above information.

Similarly to the display section 120b described above, the printing section 120c prints out the various kinds of information stored in the temporary storage device in the resin appearance design processing section 120, in accordance with a processing command entered from the design input section 120a.

For the printing device, a printer such as a page printer or any other kind of device such as a plotter can be used, provided that the device is capable of printing the above information.

The operation of each section of the apparatus will be described below.

As earlier noted, the apparatus is equipped with at least either one of (A) the pattern prediction function and (B) the color prediction function. The process flow of each function will be described below, first the function (A) and then the function (B).

With the pattern prediction function (A), (A1) information (prediction information) such as a processing program and parameters necessary for predicting an image is created in advance by using the pattern material, base resin color, and image information obtained from a large number of standard sample resin moldings, and (A2) the pattern material for trial/commercial production of a resin having a novel design quality created by image design is predicted using the prediction information. The process flow will be described below in the order of (A1) and (A2).

First, the operation of each section of the apparatus will be described when creating the prediction information in advance by using the pattern material, base resin color, and image information obtained from a large number of standard sample resin moldings in the above processing (A1). That is, in the prediction processing section 130, the prediction information is updated in accordance with the following steps (1) to (4) and, based on the resultant image or color information, it is determined in step (5) whether the process should be terminated; by repeating these steps, the prediction information is optimized.

(1) After power is turned on to the apparatus, in accordance with a control command entered from the design input section 120a (hereinafter referred to as the command from the design input section 120a) image or color information is loaded into the temporary storage device in the resin appearance design processing section 120 from the image color information input section 100 or the external information input/output section 150 or from the image color information storing section 110 in which the image or color information is stored in advance.

The image or color information loaded at this time concerns a target image for which the prediction information is to be created (hereinafter referred to as the reference image) and a plurality of original images used for the creation of a synthesized image. The target and the original images are captured from resins for which data describing the kinds and mixing ratios of the pattern material and base resin material and the color, particle distribution, etc. of the pattern material itself (hereinafter called the pattern material information) are known.

(2) As in the above step (1), the pattern material information is input into the temporary storage device in the resin appearance design processing section 120 from the design input section 120a or the external information input/output section 150.

(3) In accordance with the command from the design input section 120a, the image or color information stored in the temporary storage device in the above step (1) is transferred to the prediction processing section 130 together with the pattern material information input in the above step (2) and a prediction information create command entered from the design input section 120a.

(4) In accordance with the image or color information, the pattern material information, and the prediction information create command thus transferred, the prediction processing section 130 performs processing for the creation of a synthesized image by using preset values, and the result of the processing is supplied to the display section 120b and/or the printing section 120c via the resin appearance design processing section 120.

(5) Based on the synthesized image output on the display section 120b and/or the printing section 120c, it is determined whether the image has a texture that matches the reference image; if it is acceptable, the prediction information created up to the above step (4) is stored in the prediction information storing section 140, but if it is not acceptable, the process from the steps (1) to (4) is repeated by changing the pattern material information and the original images used.

The prediction information thus created and prestored in the prediction information storing section 140 is read out together with the synthesized image prestored in the image color information storing section 110, and is reused for the creation of the prediction information in the above process; by so doing, the image prediction accuracy can be enhanced.

The image synthesizing method employed in the apparatus uses pixel-by-pixel selection processing in order to express the pattern material portions in the image without impairing its naturalness. That is, of pixels located at the same position in the plurality of original images used for the synthesis, a certain pixel is selected as a pixel for the synthesized image in accordance with a predetermined synthesis rule; for example, the image is synthesized in accordance with a rule that the pixel of the lowest lightness is selected.

Furthermore, in the case of a pattern material of a particularly small particle size, the base color is influenced by the color of the pattern material, depending on the amount of the material mixed; therefore, the image synthesis includes a function to correct for such an influence. More specifically, a neural network is applied to the prediction information creation in the above steps (1) to (4) performed using resins manufactured with various kinds of pattern materials, and the constructed network itself is the prediction information created in the prediction processing section 130.

The image synthesis and the correction of the base resin color using a neural network will be described in further detail below as a first specific example.

For the plurality of original images, sample resin moldings are produced by using the same base resin material and same pattern material, but by varying the mixing ratio of the pattern material relative to the base resin material, i.e., 0.001, 0.005, 0.01, 0.05, 0.1, 0.15, and 0.2, respectively, and image data of their resin designs are obtained. The pattern material used for the production of the sample resin moldings is as close as possible to black in color. By applying the previously described rule that the image of the lowest lightness is selected, resin design data of a resin molding having any desired pattern material mixing ratio with the smallest step being 0.001, can be obtained through image synthesis. For example, if an image is synthesized in accordance with the above rule by using the resin design data of resin moldings, one having a pattern material mixing ratio of 0.01 and the other having a mixing ratio of 0.05, then a predicted image of a resin molding having a pattern material mixing ratio of 0.06 (0.01+0.05) can be obtained since the lightness is the lowest at the pattern material portion. If an image is synthesized by overlaying three images of resin design data each obtained from a different portion of the resin molding having a pattern material mixing ratio of 0.01, a predicted image of a resin molding having a pattern material mixing ratio of 0.03 can be obtained.

Next, the color of the pattern material is converted from black to the desired color. For the color conversion, it is desirable that the same conversion equation be applied to the value of each pixel in the entire predicted image in order to avoid unnaturalness, that the color of the pattern material portion of the predicted image be converted from black to the desired color, and that the color of the base resin not containing the pattern material be slightly tinted with the color of the pattern material according to the kind and the mixing ratio of the pattern material, as would be the case with a real object. For example, if the RGB values of the black pattern material are B_{R,G,B} (B_{R}, B_{G}, and B_{B}) the RGB values of the pattern material actually used are D_{R,G,B}, and the RGB values of a designated pixel in the image are X_{R,G,B}, then the color is calculated from the following equation.

$${R}_{R , G , B} - ( {R}_{R , G , B} - {X}_{R , G , B} ) \times \frac{{R}_{R , G , B} - {D}_{R , G , B}}{{R}_{R , G , B} - {B}_{R , G , B}} \qquad ( 1 )$$

Here, R_{R,G,B} is the RGB values of a molding consisting only of the base resin and not containing the color material, and the equation (1) actually consists of three equations for R, G, and B, respectively.

The color of the base resin portion of the synthesized image thus obtained is actually the color obtained by converting, using the equation (1), the color of the base resin of the sample resin molding whose base resin portion is the darkest in color of all the sample resin moldings used for the synthesis. Accordingly, if the color of the sample resin whose base resin portion is the darkest in color of all the sample resins used for the synthesis is the same, then the color of the base resin portion is the same irrespectively of the mixing ratio of the pattern material. In actuality, however, even if the same base resin is used, the color of the base resin changes with the mixing ratio of the pattern material; therefore, correction is applied using a neural network.

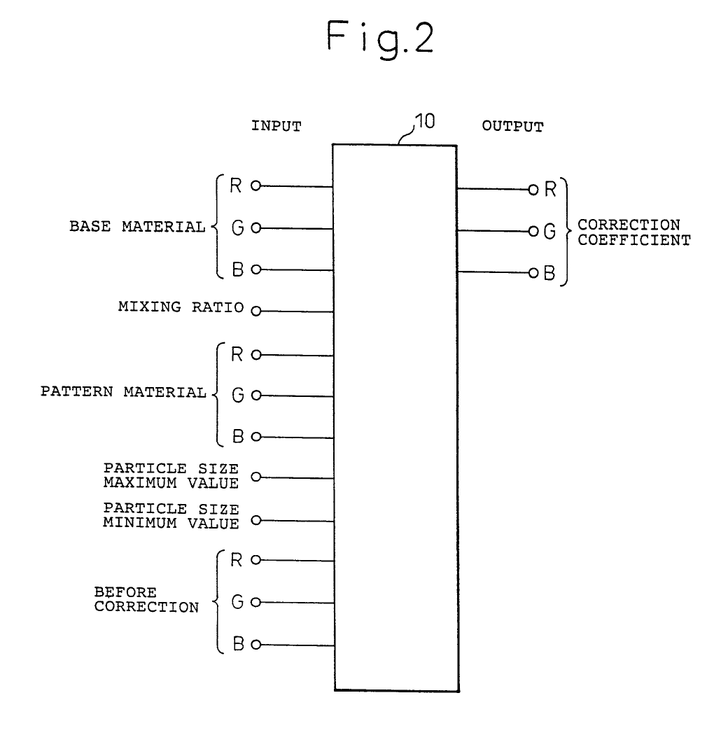

The neural network shown in FIG. 2 is constructed and is trained by supplying teaching data. For input data, the RGB values obtained by measuring the color of the molding consisting only of the base resin and not containing the pattern material are input as the RGB of the base resin material. The RGB of the base resin portion of the synthesized image, obtained by the above-described image synthesis and color conversion, is given as the RGB values before correction. Further, RGB values are measured on the base resin portion of a resin molding produced in accordance with a prescription, and a correction coefficient=(actual average base pixel value)/(average base pixel value before correction) is supplied as the teaching data. The average base pixel value refers to the average value of five pixels selected from a region corresponding to the base resin. Table 1 shows one example of the teaching data.

TABLE 1

| Input data | | | | | | | | | | | | | | |
|---|---|---|---|---|---|---|---|---|---|---|---|---|---|---|
| | | | | | | | | | Average base | | | | | |
| | | | | Color of | | | Range of | | pixel value | | | | | |
| Color of base | | | | pattern | | | particle | | before | | | Output data | | |
| material | | | Mixing | material | | | size | | correction | | | Correction coefficient | | |
| R | G | B | ratio | R | G | B | Max. | Min. | R | G | B | R | G | B |
| 218 | 217 | 211 | 0.03 | 45 | 47 | 49 | 30 | 150 | 147 | 147 | 155 | 0.6735 | 0.7075 | 0.6839 |
| 214 | 218 | 213 | 0.06 | 47 | 46 | 51 | 30 | 150 | 92 | 94 | 99 | 0.9783 | 0.9787 | 1.0202 |
| 218 | 217 | 212 | 0.01 | 66 | 57 | 53 | 30 | 150 | 180 | 163 | 160 | 0.9889 | 1.0123 | 0.9875 |
| 218 | 215 | 214 | 0.01 | 67 | 58 | 54 | 7 | 10 | 204 | 204 | 201 | 0.9951 | 0.9853 | 1.0100 |
| 214 | 218 | 213 | 0.02 | 47 | 46 | 50 | 30 | 150 | 148 | 148 | 154 | 0.8649 | 0.8919 | 0.8831 |
| 216 | 218 | 212 | 0.03 | 46 | 46 | 51 | 20 | 50 | 169 | 169 | 176 | 0.8166 | 0.8402 | 0.8409 |
| 215 | 216 | 213 | 0.075 | 46 | 46 | 50 | 30 | 150 | 98 | 101 | 106 | 0.6224 | 0.7327 | 0.6698 |

The prediction information creation in (A1) is thus completed. The prediction of the pattern of a resin molding containing one kind of pattern material, which becomes necessary in (A2), is performed in the following manner. To predict the pattern of a resin containing a red pattern material in a mixing ratio of 0.06, for example, the image of a resin containing the black pattern material in a mixing ratio of 0.01 and the image of a resin containing the black pattern material in a ratio of 0.05, stored in the image color information storing section 110, are combined to produce a synthesized image in accordance with the previously described rule, and the color conversion is performed using the equation (1) but substituting the RGB values of the red pattern material for the D_{R,G,B} in the equation (1). Then, the necessary values are input to the neural network of FIG. 2, and the resulting correction coefficient output for color correction is applied to multiply the pixel value of each pixel in the resin image after the color conversion, thereby obtaining the predicted image of the resin containing the red pattern material in a mixing ratio of 0.06.

Next, a second example of the base resin color correction performed using a neural network will be described below. The process is the same up to the image synthesizing step but in the first example described above the correction using a neural network is applied after the color conversion and in the second example the color conversion is performed after correcting the lightness value Y by using a neural network.

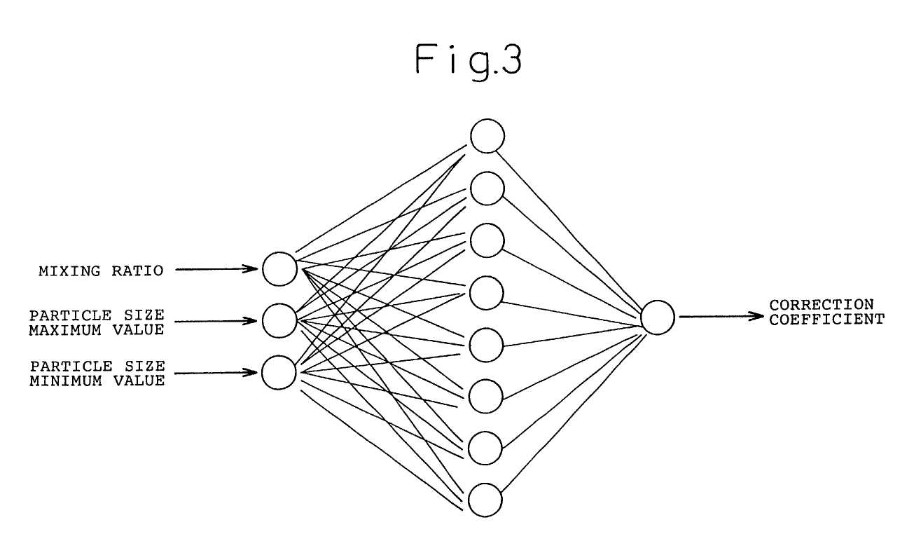

FIG. 3 is a diagram showing an example of the neural network used in the second example. Further, Table 2 shows one example of the teaching data.

TABLE 2

| | Range of particle | | |
|---|---|---|---|
| | size | | Correction |
| Mixing ratio | Max. | Min. | coefficient |
| 0.03 | 30 | 150 | 0.83 |
| 0.06 | 30 | 150 | 0.98 |
| 0.01 | 30 | 150 | 0.85 |
| 0.01 | 7 | 10 | 0.98 |
| 0.05 | 30 | 150 | 0.70 |
| 0.03 | 20 | 50 | 0.87 |
| 0.075 | 30 | 150 | 0.88 |

The calculation of the lightness value Y from the RGB values is performed using the following equation.

Y=0.3R+0.59G+0.11B (2)

In the prediction of the pattern of a resin molding containing one kind of pattern material, which becomes necessary in (A2), the correction and the color conversion are performed simultaneously in accordance with the following equation by using the correction coefficient P that the neural network of FIG. 3 outputs.

$${R}_{R , G , B} - ( {R}_{R , G , B} - P \times {X}_{R , G , B} ) \times \frac{{R}_{R , G , B} - {D}_{R , G , B}}{{R}_{R , G , B} - {B}_{R , G , B}} \qquad ( 3 )$$

where B_{R,G,B} represents the RGB values of the pixel having the lowest lightness in the image.

The neural network has been used here as the correcting means, but it will be noted that other techniques that can accomplish an equivalent effect and, for example, multiple regression analysis, etc., can be used instead of the neural network.

Furthermore, the image synthesis is not limited to using the rule and technique described above, but lightness or chroma information may be used in the rule, and a technique of labeling a pattern material portion from an image and synthesizing an image from the pattern information and image label information, for example, may be employed as the image synthesis technique.

Next, a description will be given of the operation of each section of the apparatus in (A2) in which the pattern material is predicted by using the prediction information created in (A1).

(1) After power is turned on to the apparatus, the pattern material information is loaded into the temporary storage device in the resin appearance design processing section 120 from the design input section 120a or the external information input/output section 150 in accordance with the command entered from the design input section 120a, as in the process (A).

(2) The pattern material information stored in the temporary storage device in the above step (1) is transferred to the prediction processing section 130 together with the image prediction command entered from the design input section 120a.

(3) Based on the image prediction command and the pattern material information in the above step (2), the prediction processing section 130 reads previously created prediction information from the prediction information storing section 140 and, using the prediction method described later, performs processing to predict an image from the prediction information and the image data read out of the image color information storing section 110, and an image representing the result of the prediction is output onto the display section 120 and/or the printing section 120c by way of the resin appearance design processing section 120.

(4) The steps (1) to (3) are repeated by varying the pattern material information used until it is determined that the predicted image obtained has the desired texture, and the pattern material information when the desired texture is obtained is taken as the material information for the desired resin.

(5) Based on a command entered from the design input section 120a, the predicted image is stored in the image color information storing section 110 and/or output to the external information input/output section 150 as required.

Next, the image prediction method used in the prediction processing section 130 of the apparatus will be described below.

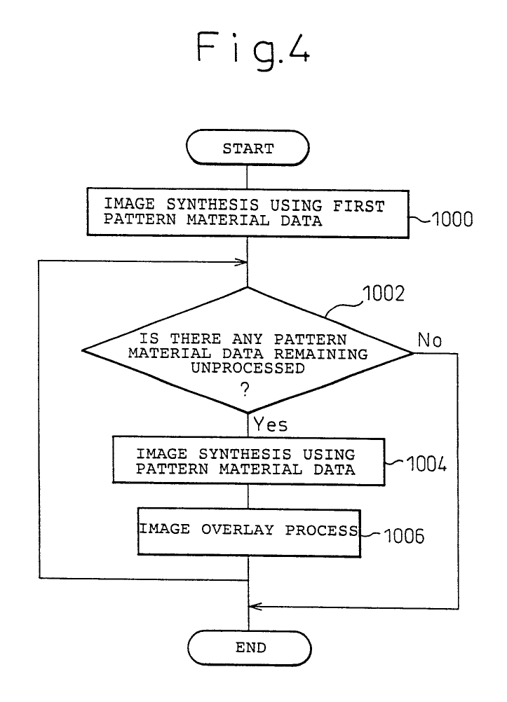

FIG. 4 is a flowchart illustrating the image prediction process carried out in the prediction processing section 130. In this method, the prediction of an image using multiple kinds of pattern material data is accomplished by overlaying a plurality of images of resin moldings by using a technique described later; here, each of the plurality of images is obtained by the above-described method of synthesizing a resin molding image using one kind of pattern material data.

In step 1000, first an image that matches certain pattern material data is synthesized from the pattern material data by using the earlier described technique. For example, an image that uses 3% by weight of a red pattern material having a particle size of 30 to 150 mesh is synthesized in accordance with the prescribed synthesis rule described previously.

Next, in step 1002, it is determined whether there is any pattern material data remaining unprocessed. If there is no pattern material data remaining unprocessed, the image prediction process is terminated; otherwise, the process proceeds to step 1004.

In step 1004, image synthesis similar to that performed in step 1000 is performed using another kind of pattern material data, after which the process proceeds to step 1006. For example, an image that uses 0.5% by weight of a green pattern material having a particle size of 7 to 10 mesh is synthesized here.

In step 1006, the image synthesized in step 1004 is overlaid on the previously created image, after which the process returns to step 1002. For example, the synthesized image that uses 3% by weight of the red pattern material having a particle size of 30 to 150 mesh and the synthesized image that uses 0.5% by weight of the green pattern material having a particle size of 7 to 10 mesh are overlaid one on top of the other to synthesize an image.

A specific example of the image overlay process will be described below.

The apparatus uses the following nonlinear operation in the image overlay process as a technique for achieving the creation of an overlaid image retaining the naturalness that the image had before the processing.

Nonlinear operation: Using two images A and B, when overlaying the image A on the image B, new pixel information is created by a nonlinear operation from the image information of a certain pixel in the image A and the pixel information of the image B at the location corresponding to the overlay position of that pixel. By repeating this operation, a new image C is created.

Further, as a technique for processing information of each pixel (for example, RGB values, hereinafter referred to as the pixel value) nonlinearly, the present invention calculates the composition ratio, 1-r, of the image A and the composition ratio, r, of the image B from the following equation using a sigmoid function.

r=(α^{x}−β^{x})^{Y}/(α^{x}+β^{Y})^{Y} (4)

where

r=Composition ratio of image B

α=Maximum lightness value of image A—Minimum lightness value of image A

β=Lightness value of a certain pixel in image A—Minimum lightness value of image A

Next, the pixel value of the image C is calculated from the pixel values of the images A and B by using the following equation.

(1-r)×(Pixel value of image A)+r×(Pixel value of image B) (5)

That is, using the composition ratio, 1-r, of the image A and the composition ratio, r, of the image B obtained by the equation (4), a new pixel value is calculated from the respective pixel values, and the calculated pixel value is taken as the pixel value of the synthesized image.

Here, preferably the values of the exponents X and Y of the function in the equation (4) differ depending on the particle size of the pattern material used. More specifically, if the particle size of the pattern material used is small (30 mesh at the maximum end), then X=5 and Y=3, and if the particle size is large (10 mesh at the minimum end), then X=4 and Y=2, while in the case of a medium particle size (particle size in-between), X=3 and Y=3.

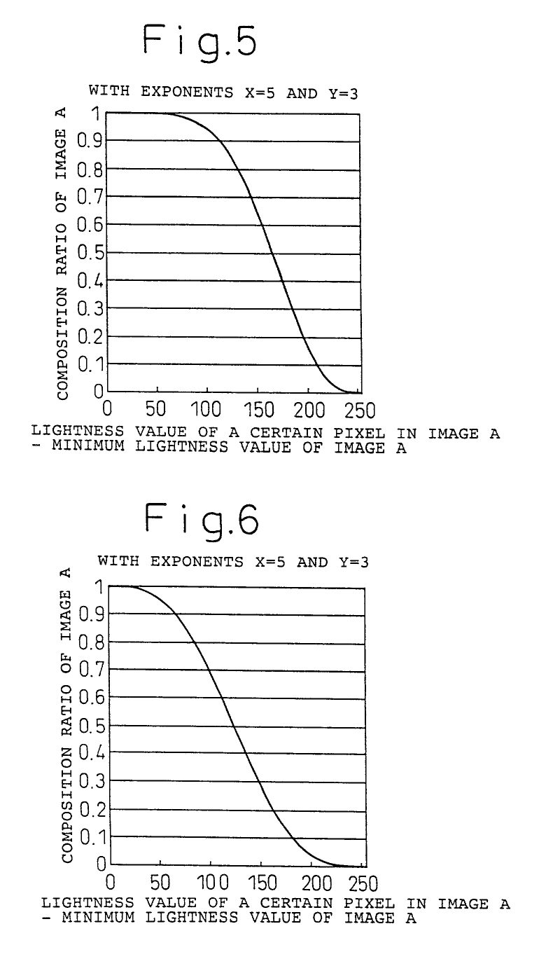

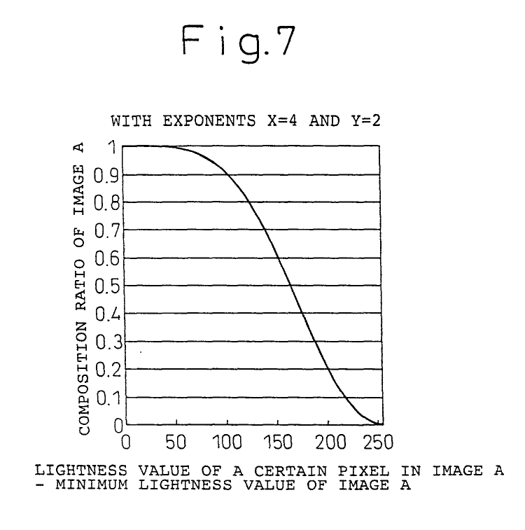

FIGS. 5, 6, and 7 show the relation of the equation (4) for X=5 and Y=3, X=3 and Y=3, and X=4 and Y=2, respectively.

Next, the process flow of the color prediction function (B) will be described below.

With the color prediction function (B), (B1) information (prediction information) such as a processing program and parameters necessary for predicting color from color material data is created in advance by using color information obtained from a large number of standard resin samples and color material information (color material data) used to produce the samples, and (B2) the color material for trial/commercial production of a resin having a novel design quality created by color design is predicted using the prediction information. The process flow will be described below in the order of (B1) and (B2).

First, the operation of each section of the apparatus will be described when creating the prediction information in advance by using the color material and color information obtained from a large number of standard sample resins in the above processing (B1). That is, using the method described in (4) below, the prediction processing section 130 creates the prediction information from the information obtained by repeating the following steps (1) to (3).

(1) After power is turned on to the apparatus, in accordance with a command from the design input section 120a the color information is loaded into the temporary storage device in the resin appearance design processing section 120 from the image color information input section 100 or the external information input/output section 150 or from the image color information storing section 110 in which the color information is stored in advance.

(2) As in the above step (1), the color material information is input into the temporary storage device in the resin appearance design processing section 120 from the design input section 120a or the external information input/output section 150.

(3) In accordance with a command from the design input section 120a, the color information stored in the temporary storage device in the above step (1) is transferred to the prediction processing section 130 and, at the same time, the color material information input in the above step (2) and a prediction information create command entered from the design input section 120a are transferred to the prediction processing section 130.

(4) Based on the prediction information create command in the above step (3), the prediction processing section 130 collects the color material data transferred in the above step (2) and the color information transferred in the above step (3) each time the above process from (1) to (3) is repeated, and creates the prediction information from the thus collected color information and stores it in the prediction information storing section 140.

The prediction information previously created and stored in the prediction information storing section 140 is read out, and the prediction information is created again with reference to the color information collected above and is stored in the prediction information storing section 140.

In the apparatus, the neural network described hereinafter is used for the prediction of color information from the color material data, and the network itself, constructed using a standard resin, is the prediction information created in the prediction processing section 130.

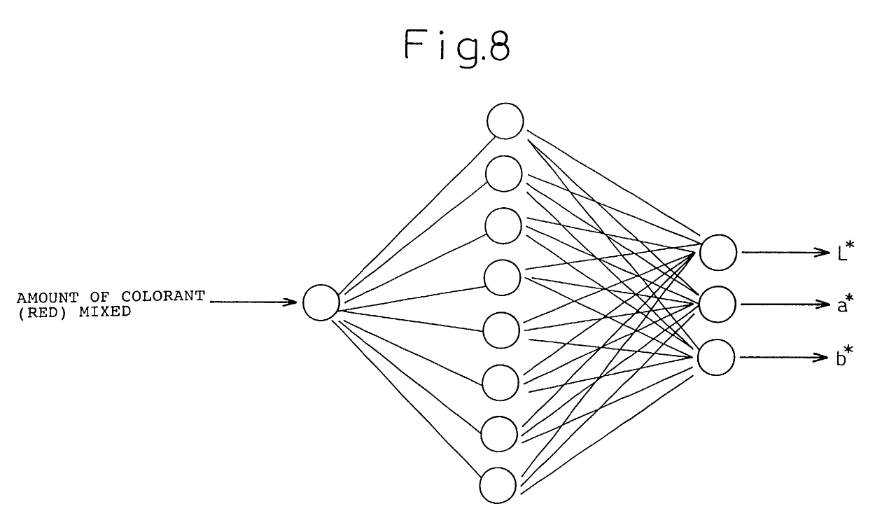

More specifically, in the prediction information creation in (B1), a network defining the relationship between the color information and the color material used in each resin is constructed. For example, as shown in FIG. 8, the network is constructed by supplying teaching data to a neural network which accepts at its input the amount of colorant as the color material data of the resin, and outputs the colorimetric values (L*, a*, b*) of the resin molding as the color information of the resin molding; here, the teaching data consists of the amount of colorant added and the colorimetric values (L*, a*, b*) of each of the resins produced by varying the amount of colorant. Table 3 shows one example of the teaching data.

TABLE 3
Teaching data

| Input Red | Output L* | Output a* | Output b* |
|---|---|---|---|
| 1.000 | 46.12 | 31.49 | 24.43 |
| 0.500 | 50.85 | 30.56 | 23.71 |
| 0.300 | 55.29 | 28.92 | 22.34 |
| 0.200 | 59.54 | 27.03 | 21.46 |
| 0.100 | 65.65 | 22.71 | 17.73 |
| 0.075 | 68.35 | 20.90 | 16.47 |
| 0.050 | 71.96 | 18.11 | 14.60 |
| 0.025 | 77.21 | 13.47 | 11.80 |
| 0.010 | 82.70 | 7.75 | 8.34 |
| 0.005 | 85.34 | 4.77 | 6.72 |
| 0.001 | 88.57 | 0.91 | 4.62 |

Such a neural network is constructed for each colorant used, and a neural network is also constructed for a resin containing two kinds of colorants in a ratio of 1:1 by weight.

The neural network has been used here as the prediction information creating means, but it will be noted that other techniques that can accomplish an equivalent effect and, for example, discriminant analysis, fuzzy logic, etc. can be used instead of the neural network.

Next, a description will be given of the operation of each section of the apparatus in the above-described process (B2) in which the color material is predicted by using the prediction information created in the process (B1).

In this process, the color material data for obtaining the color information of the target color made visible in the following step (1) is created by repeating the steps (2) to (4) below.

(1) After power is turned on to the apparatus, first the color of the target resin molding is displayed. That is, as in the process (A), in accordance with the command from the design input section 120a, the color information is loaded into the temporary storage device in the resin appearance design processing section 120 from the image color information input section 100 or the external information input/output section 150 or from the image color information storing section 110 in which the color information is stored in advance. This information is made visible by the display section 120b and/or the printing section 120c.

(2) In accordance with the color material prediction command entered from the design input section 120a, the color material data input from the design input section 120a is transferred to the prediction processing section 130 and, at the same time, the color material prediction command entered from the design input section 120a is also transferred.

(3) Based on the color material prediction command in the above step (2), the prediction processing section 130 reads previously created prediction information from the prediction information storing section 140 and, using the prediction information, predicts the color information from the color material data transferred in the above step (2), and information representing the result of the prediction is output onto the display section 120b and/or the printing section 120c via the resin appearance design processing section 120.

(4) The steps (2) and (3) are repeated by varying the color material data used until it is determined that the obtained color information matches the desired color, and the color material data when the desired color is obtained is taken as the color material data for the desired resin molding.

(5) Based on a command entered from the design input section 120a, the color material data is stored in the image color information storing section 110 and/or output to the external information input/output section 150 as required.

Next, the method of predicting the color information from the color material data, used in the prediction processing section 130 of the apparatus, will be described below.

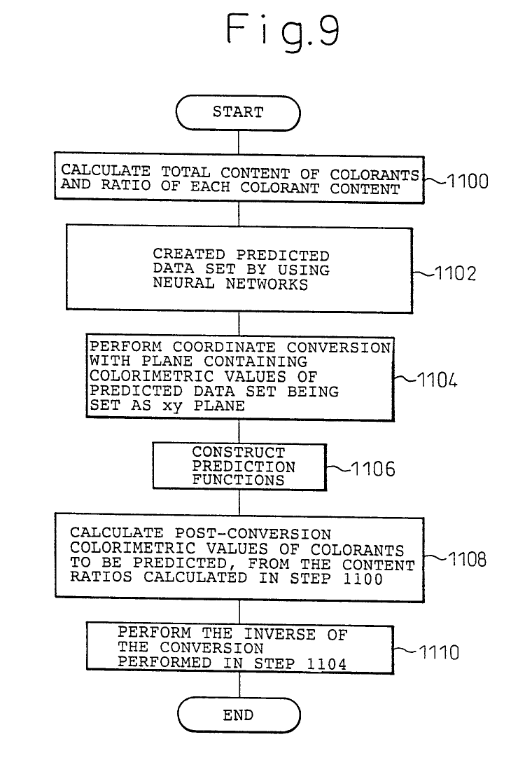

FIG. 9 is a flow chart illustrating the color information prediction process carried out in the prediction processing section 130. In step 1100, the total content of colorants and the ratio of the content of each colorant to the total content, with the total content being 1, are calculated from the color material data. For example, if the red colorant content is 0.04 g/kg and the yellow colorant content is 0.01 g/kg, then the total colorant content is 0.05 g/kg and the ratio of the yellow colorant content is 0.2.

Next, in step 1002, the L*, a*, b* values of a resin containing only one of the two kinds of colorants in an amount equal to the total content obtained in step 1000, the L*, a*, b* values of a resin containing only the other colorant in an amount equal to the total content obtained in step 1000, and the L*, a*, b* values of a resin molding containing the two kinds of colorants in a ratio of 1:1 by weight and in an amount equal to the total content obtained in step 1000, are predicted using the neural networks constructed in (B1). In the above example, the L*, a*, b* values of a resin molding containing only the red colorant in an amount of 0.05 g/kg, the L*, a*, b* values of a resin molding containing only the yellow colorant in an amount of 0.05 g/kg, and the L*, a*, b* values of a resin containing the red and yellow colorants each in an amount of 0.025 g/kg, are predicted.

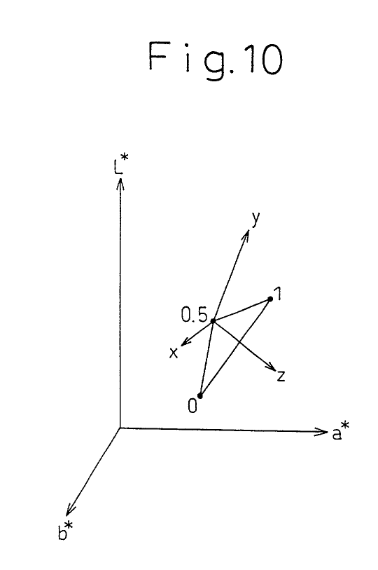

In step 1104, coordinate conversion is performed to reduce the dimensionality of the variables of calorimetric values in the predicted data set obtained in step 1102. That is, it is assumed that when the ratio of one of the two colorants is varied from 0 to 1 while holding the total content of the two colorants constant, the locus of points representing the color of the resin molding always lies on the same plane within the orthogonal three-dimensional space defined by the a* axis, b* axis, and L* axis. As shown in FIG. 10, three points representing the color of the resin molding when the ratio of one of the colorants is 0, 0.5, and 1, respectively, are plotted within the orthogonal three-dimensional space defined by a*, b*, and L*, and x- and y-axes orthogonal to each other with the point of the ratio 0.5 at the origin are taken in a plane containing the three points, while the z-axis is taken passing through the origin and orthogonal to the x- and y-axes. Using a 3×3 conversion matrix T for conversion from three-dimensional coordinates (a*, b*, L*) to three-dimensional coordinates (x, y, z), the coordinate conversion

$$( \begin{matrix}{a}^{*} & {b}^{*} & {L}^{*}\end{matrix} ) \times T = ( \begin{matrix}x \\ y \\ z\end{matrix} ) \qquad ( 6 )$$

is performed; then, since the z-coordinate after the coordinate conversion is always 0 as the result of the above setting, the color of the resin molding when the total content is constant can be represented by two coordinate values x=x′ and y=y′.

The color system used to present the colorimetric values is not limited to the L*a*b* color system, but any color system can be used. For example, the XYZ color system can be used. Further, the conversion is not limited to the conversion from the coordinates (a*, b*, L*) to the coordinates (x, y, z), but the conversion may be performed from the coordinates (L*, a*, b*) to the coordinates (x, y, z).

Next, in step 1106, functions for performing predictions (hereinafter referred to as the prediction functions) are constructed by using the three sets of calorimetric data obtained from the coordinate conversion (hereinafter referred to as the post-conversion calorimetric values). Here, two kinds of prediction functions are constructed, that is, a function for predicting one post-conversion colorimetric value x′ or y′ from the ratio of the content (hereinafter referred to as the content ratio—post-conversion calorimetric value prediction function) and a function for predicting the other post-conversion calorimetric value y′ or x′ from the one post-conversion calorimetric value x′ or y′ (hereinafter referred to as the post-conversion calorimetric value inter-prediction function).

The functions in the above step 1106 are constructed in the following way.

First, using the equation

y=A+Bx^{(α/β)} where α and β are natural numbers (7)

the content ratio—post-conversion calorimetric value prediction function is determined from the content ratios at the three points and the post-conversion calorimetric values in the prediction data set. That is, values 0, 0.5, and 10 representing the respective content ratios are substituted for the value of x in the equation (7), x′ values at the three points of the corresponding post-conversion calorimetric values are substituted for the value of y in the equation (7), two arbitrary natural numbers are substituted for α and β in the equation (7), an approximation is performed using a least square method, and the combination of α and β that minimizes the mean value of squares of approximation errors (mean square residual) and the values of A and B at that time are taken to determine the prediction function.

The post-conversion calorimetric value inter-prediction function is also constructed using the post-conversion colorimetric values, that is, x′ and y′ at the three points are substituted for x and y in the equation

y=Ax²+Bx+C (8)

to calculate coefficients A, B, and C, and the resulting values are taken to determine the function.

In the construction of the above prediction functions, y′ may be used instead of x′ as the value for the variable y in the equation (7), and y′ and x′ may be used instead of x′ and y′ for x and y in the equation (8).

In step 1108, using the prediction functions constructed in the above step 1106, x′ and y′ for the color material data of the colorant to be predicted are calculated from the content ratio obtained in step 1100.

Finally, in step 1110, the inverse of the conversion performed in step 1104 is performed. That is, the coordinate values x′, y′, and z′ (=0) are multiplied by an inverse matrix T⁻¹ which is the inverse of the conversion matrix T, thereby converting them back to the original three-dimensional coordinates a*, b*, and L*. The processing in the prediction processing section 130 is thus completed.

In Table 4, prediction errors between the results of the color predictions made by the system of the invention and the results of the color measurements taken on the resins prepared in accordance with formulations are shown in terms of the color difference

$$Δ E ( = \sqrt{{( Δ {L}^{*} )}^{2} + {( Δ {a}^{*} )}^{2} + {( Δ {b}^{*} )}^{2}} )$$

For reference, Table 5 shows the reproducibility of the results of the color measurements made on a plurality of resin moldings prepared in accordance with the same formulations. A comparison between Table 4 and Table 5 shows that the color has successfully been predicted within the limits of the manufacturing and measurement reproducibility.

TABLE 4
Color prediction errors with the system of
the invention

| Red | Yellow | Prediction error |
|---|---|---|
| (g/Kg total) | (g/Kg total) | (Color difference: ΔE) |
| 0.40 | 0.10 | 0.99 |
| 0.20 | 0.30 | 1.74 |
| 0.10 | 0.40 | 1.61 |
| 0.04 | 0.01 | 0.63 |
| 0.02 | 0.03 | 1.60 |
| 0.01 | 0.04 | 1.39 |

TABLE 5
Amount of colorant and reproducibility
of manufacturing

| Red | Yellow | Reproducibility |
|---|---|---|
| (g/Kg total) | (g/Kg total) | (Color difference: ΔE) |
| 0.10 | 0.10 | 2.31 |
| 0.01 | 0.01 | 0.62 |
| 0.00 | 0.05 | 2.04 |

As described above, in the color material information prediction method employed in the apparatus, the prediction of color information from the color material information is repeatedly performed until an optimal solution is found.

However, the procedure for the color material prediction is not limited to the specific method employed in the apparatus and, for example, the color material information may be predicted directly from the color information.

One embodiment of the present invention has been described above with reference to drawings, but it will be appreciated that the specific configuration is not limited to the one disclosed in the embodiment, and that all design changes, etc. made without departing from the essential characteristics of the invention also fall within the scope of the invention.

1. A resin appearance designing method comprising the steps of:
(a) capturing images of a plurality of sample resin moldings whose pattern material information is known;
(b) synthesizing an image from a plurality of images selected from among the captured images on the basis of pattern material data;
(c) outputting the synthesized image: and
(d) repeating the steps (b) and (c) by varying the pattern material data until the output image shows a desired resin pattern, and thereby determining the pattern material data for obtaining a resin molding having the desired resin pattern.

2. A method according to claim 1, wherein images of sample resin moldings containing one predetermined kind of pattern material are captured in the step (a), and wherein the step (b) includes the substeps of:
(i) synthesizing an image from the images of the sample resin moldings in accordance with the pattern material data; and
(ii) converting the color of each pixel in the synthesized image so that the color of a pattern material portion of the synthesized image matches the pattern material data.

3. A method according to claim 2 wherein, in the substep (b)(ii), the color of a base resin portion is corrected in accordance with a mixing ratio of the pattern material.

4. A method according to claim 3, wherein the color of the base resin portion is corrected using a neural network.

5. A method according to claim 2, wherein the step (b) further includes the substep of (iii) generating an image of a resin molding containing multiple kinds of pattern materials by combining a plurality of images obtained by repeating the substeps (i) and (ii) for different kinds of pattern materials.

6. A method according to claim 5 wherein, when combining two images in the substeps (b)(iii), pixel values for the synthesized image are calculated by summing pixel values of respectively corresponding pixels in the two images in accordance with composition ratios calculated using a sigmoid function.

7. A resin appearance designing method comprising the steps of:
(a) predicting the color of a resin molding from color material data;
(b) outputting the predicted color of the resin molding in the form of an image; and
(c) repeating the steps (a) and (b) by varying the color material data until the output image matches an image of a resin molding having a desired color, and thereby determining the color material data for obtaining the resin molding having the desired color.

8. A resin appearance designing method according to claim 7, wherein the step (a) includes the substeps of:
(i) constructing a neural network capable of predicting, for an arbitrary total colorant content, the color of a resin molding containing only one kind of colorant out of colorants to be used and the color of a resin molding containing two kinds of colorants in a prescribed weight ratio;
(ii) predicting, by using the neural network, the color of a resin molding containing only one of the two kinds of colorants in an amount equal to the total content determined based on the color material data, the color of a resin molding containing only the other of the two kinds of colorants in an amount equal to the total content, and the color of a resin molding containing the two kinds of colorants in the prescribed weight ratio in an amount equal to the total content; and
(iii) determining, from the three predicted colors, the color of a resin molding containing the two kinds of colorants in content ratios determined based on the color material data and in an amount equal to the total content.

9. A method according to claim 8, wherein the substep (a)(iii) includes the substeps of:
converting three sets of three-dimensional coordinates, respectively representing the three colors, into three sets of two-dimensional coordinates;
determining from the three sets of two-dimensional coordinates a first calculation equation for calculating one coordinate value of the two-dimensional coordinates from the content ratios;
determining from the three sets of two-dimensional coordinates a second calculation equation for calculating the other coordinate value from the one coordinate value of the two-dimensional coordinates;
calculating, from the content ratios determined based on the color material data, corresponding two-dimensional coordinates by using the first and second calculation equations; and
converting the calculated two-dimensional coordinates back to the three-dimensional coordinates representing the colors.

10. A resin appearance designing apparatus comprising:
means for capturing images of sample resin moldings;
means for storing the images captured by the capturing means;
means for synthesizing an image from a plurality of images selected from among the stored images; and
means for outputting the synthesized image.

11. An apparatus according to claim 10, wherein the image synthesizing means includes:
means for synthesizing an image from the images of the sample resin moldings stored in the storing means, in accordance with pattern material data; and
means for converting the color of each pixel in the synthesized image so that the color of a pattern material portion of the synthesized image matches the pattern material data.

12. An apparatus according to claim 11, wherein the color conversion means includes means for correcting the color of a base resin portion in accordance with a mixing ratio of the pattern material.

13. An apparatus according to claim 12, wherein the means for correcting the color of the base resin portion includes a neural network.

14. An apparatus according to claim 11, wherein the image synthesizing means further includes second image synthesizing means for synthesizing an image from a plurality of images obtained by combining the images of the sample resin moldings and by performing the color conversion for different colors.

15. An apparatus according to claim 14 wherein, when combining two images, the second image synthesizing means calculates pixel values for the synthesized image by summing pixel values of respectively corresponding pixels in the two images in accordance with composition ratios calculated using a sigmoid function.

16. A resin appearance designing apparatus comprising:
means for predicting the color of a resin molding from color material data; and
means for outputting the predicted color of the resin molding in the form of an image.

17. A resin appearance designing apparatus according to claim 16, further comprising:
a neural network capable of predicting, for an arbitrary total colorant content, the color of a resin molding containing only one kind of colorant out of colorants to be used and the color of a resin molding containing two kinds of colorants in a prescribed weight ratio, and wherein
the predicting means includes:
means for predicting, by using the neural network, the color of a resin molding containing only one of the two kinds of colorants in an amount equal to the total content determined based on the color material data, the color of a resin molding containing only the other of the two kinds of colorants in an amount equal to the total content, and the color of a resin molding containing the two kinds of colorants in the prescribed weight ratio in an amount equal to the total content; and
means for determining, from the three predicted colors, the color of a resin molding containing the two kinds of colorants in content ratios determined based on the color material data and in an amount equal to the total content.

18. An apparatus according to claim 17, wherein the color determining means:
means for converting three sets of three-dimensional coordinates, respectively representing the three colors, into three sets of two-dimensional coordinates;
means for determining from the three sets of two-dimensional coordinates a first calculation equation for calculating one coordinate value of the two-dimensional coordinates from the content ratios;
means for determining from the three sets of two-dimensional coordinates a second calculation equation for calculating the other coordinate value from the one coordinate value of the two-dimensional coordinates;
means for calculating, from the content ratios determined based on the color material information, corresponding two-dimensional coordinates by using the first and second calculation equations; and
means for converting the calculated two-dimensional coordinates back to the three-dimensional coordinates representing the colors.
